(19) United States
(12) Patent Application Publication
(10) Pub. No.: US 2007/0133691 A1
(43) Pub. Date: Jun. 14, 2007

(54) Method and apparatus for layered rateless coding

(75) Inventor: Ulas C. Kozat, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: DoCoMo Communications Laboratories USA, Inc.

(21) Appl. No.: 11/605,812

(22) Filed: Nov. 27, 2006

Related U.S. Application Data
(60) Provisional application No. 60/740,843, filed on Nov. 29, 2005.

(51) Int. Cl. H04N 11/04

(52) U.S. Cl. 375/240.24

(57) ABSTRACT

A method and apparatus for layered rateless coding are described. In one embodiment, the method comprises dividing content into a plurality of content layers based on priority; expanding each layer into an encoded layer using an erasure code at a coding rate to produce a plurality of encoding layers, wherein the coding rate for each layer is set based on the priority and reduces as the priority of the content layers increases; concatenating a plurality of encoding layers produced by passing the plurality of layers through fixed rate precoders; and performing rateless encoding on the concatenated plurality of encoding layers to produce rateless encoding blocks.

This application claims priority to and incorporates by reference U.S. Provisional Application No. 60/740,843, entitled “A Method and Apparatus for Layered Rateless Codes,” filed Nov. 29, 2005.

### FIELD OF THE INVENTION

The present invention relates in general to coding theory, channel codes, layered source coding, rateless codes, content distribution, P2P networking; more specifically, the present invention relates to the downloading encoded content in a mobile communication system, such as, for example, a peer-to-peer communication system, where the content has been encoded using rateless codes to reduce the overhead of distributed content delivery and increase the resilience against the unreliable network connectivity, mobility, and limited resources of mobile terminals in the communication system.

### BACKGROUND OF THE INVENTION

Rateless Codes are well-known in the art. Rateless codes such as Online Codes, LT Codes, and Raptor Codes have been proposed as methods to generate as many unique code blocks as possible from a given number of original message blocks. If there are K original message blocks, an ideal rateless code promises a full recovery of the K original blocks after receiving K code blocks. In practice, however, rateless codes are only asymptotically perfect and they are able to recover the K original blocks with high fidelity after receiving (I+ε)×K code blocks, where ε goes to 0 as K gets larger. Despite this inefficiency, rateless codes have some very desirable properties over the fixed rate codes. In particular, they can adapt against changes in the communication environment on the fly by generating as many unique coded blocks as needed in a lossy environment without a prior knowledge of how bad or how good the packet losses are between the communication entities. Moreover, when the original content is delivered as multiple streams from multiple source nodes, source nodes do not require a prior agreement to resolve overlaps and avoid duplicate transmissions from different sites. In other words, each source node can generate unique coded blocks without any communication (or coordination) with the other source nodes by employing rateless coders. Equivalently, an original source node can itself generate as many unique encoded blocks as possible and distribute non-intersecting subsets of encoded blocks to multiple nodes in the network. Hence, rateless codes allow an uncoordinated and asynchronous delivery of the original content from multiple network nodes and/or multiple blocks of the source description.

A layered source description allows one to divide the whole description of a source such as video into a hierarchy of many layers, where as one accesses more layers in the hierarchy a better representation of the original content can be achieved. Media (e.g., video clips, music files, image) can often be described at the source in terms multiple layers of information made up of a mandatory core layer and one or more enhancement layers. In general, there is a core layer that must be recovered to achieve an acceptable quality level and there are enhancement layers that increase the quality when added on top of the core layer. Note, sometimes the enhancement layers themselves have an internal hierarchy and sometimes this hierarchy exists in subsets of layers. Such a layered source description is especially useful for multicasting and broadcasting applications where each host has different limitations on their bandwidth and end device capabilities. In order to achieve a satisfactory service quality, the core layer should be recovered at the destination node with much higher fidelity, with lower overhead, or in a shorter expected time than the latter.

A layered source description can be also artificially formed by combining different portions of content into one larger content to increase the efficiency of the system in particular here the efficiency of rateless codes. Examples include combining many small software updates into a larger software update package, combining many advertisement messages into one advertisement message, etc. In many cases, some content in this larger content is more important than the other content and must be provided with better delivery guarantees than the rest of the content included in the larger content. Hence, the large content formed to increase the efficiency of the system again can be treated as a hierarchy of many layers, each having different priorities.

Traditional rateless codes do not differentiate the different layers and provide the same level of transmission guarantees to all layers. To recover any high priority part of the content, almost all the content must be recovered increasing the failure probability in mobile downloads given the unreliable and fragile nature of the mobile communications.

### SUMMARY OF THE INVENTION

A method and apparatus for layered rateless coding are described. In one embodiment, the method comprises dividing content into a plurality of content layers based on priority; expanding each layer into an encoded layer using an erasure code at a coding rate to produce a plurality of encoding layers, wherein the coding rate for each layer is set based on the priority and reduces as the priority of the content layers increases; concatenating a plurality of encoding layers produced by passing the plurality of layers through fixed rate precoders; and performing rateless encoding on the concatenated plurality of encoding layers to produce rateless encoding blocks.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates a layered source arranged chronologically in a time-wise fashion.

FIG. 2 illustrates grouping each layer is grouped together, where each layer is represented as a sequence of blocks that each consist of a sequence of many bits.

FIG. 3 illustrates expanding layers into precoded layers.

FIG. 4 illustrates data flow for performing rateless code encoding.

FIG. 5 is a data flow diagram of one embodiment of an encoding system.

FIG. 6 is a data flow diagram of one embodiment of a decoding system.

FIG. 7 is one embodiment of a communication system that employs includes one or more mobile nodes (peers) that use the decoding system described herein.

FIG. 8 is an example of one embodiment of a computer system.

### DETAILED DESCRIPTION OF THE PRESENT INVENTION

A method and apparatus for a method for encoding and/or decoding a layered source using unequal error protection (UEP) rateless codes are disclosed. The encoding and decoding may be used in a system for distributing layered content from single or multiple points to single or multiple points. This distribution may be a content download. These differ from the traditional rateless codes that treat given content as a single unit as if each block is equally important for the receiver. They also differ from the traditional layered transmission by employing rateless codes in the packet level to achieve uncoordinated, asynchronous content download.

In one embodiment, an encoder provides unequal error protection (UEP) at the precoding stage before a rateless coding stage that generates practically an unlimited number of coded blocks, as opposed to the prior art in which UEP is applied at the rateless code stage by skewing the degree distribution output used at that stage. An advantage of this arrangement is that the output of the precoder can be concatenated with any rateless code that has a well-performing degree distribution, without requiring a joint design of skewness and degree distribution to obtain predictable performance.

In one embodiment, the layered source code is operated on at the packet level. In one embodiment, the encoder provides fine control over each layer by first grouping the packets of each layer together and expanding (e.g., pre-coding) each layer using different expansion factors, thereby giving a different level of protection for each layer. The expanded layers are concatenated further to form a single string of packets and traditional rateless codes (with or without any additional precoding as required by the particular rateless code) are applied to generate as many “encoding blocks” as desired to be able to recover the original layers. By doing so, there is a different fidelity in the download times of each layer of the entire content of interest.

In one embodiment, the encoder provides differentiated levels of service to different subsets of a transmission. In one embodiment, a layered rateless coding is performed by applying a different preceding for each layer of a content, which is presented by a plurality of layers, before applying a random rateless code structure. Thus, higher fidelity is provided when considering the source fidelity than with traditional rateless codes in the sense that embodiments of the present invention allow the core layer (i.e., a high priority layer) to be fully recovered before the enhancement layers (i.e., low priority layers), and also for enhancement layers themselves to see differentiation in transmission fidelity or time. Hence, if the transmission is interrupted between the time the core layer is fully recovered and the time required to recover the whole content, unlike the traditional rateless codes do, the receiver is still guaranteed to be able to produce a source output (e.g., a video playback, an audio playback, etc.) at least at an acceptable content quality or to recover the important subcontent portions in a larger content (e.g., critical software updates in a larger software download, more important advertisements in a collection of advertisements, etc.).

In another embodiment, a mobile peer-to-peer system stores or generates “encoding blocks” for the layered content and increases the goodput of layered content against the adverse communication environments. This system may be loosely managed and may operate in an asynchronous opportunistic fashion.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Overview

A method and apparatus for generating unequal error protected (UEP) rateless codes is disclosed. To provide unequal error protection, scalable content is expressed as multiple layers, where the base layer (referred to herein as the “first layer” or “core layer”) is received in order to improve the quality of presenting the original content when the higher order layers (referred to herein as “enhancement layers”) are received. Consequently, each layer has a different level of importance and the loss of information in lower layers has a more dramatic impact on the representation of the original content. That is, the loss of core or other lower order enhancement layers would cause substantially more distortion than the loss of higher order enhancement layers. In another application, each layer corresponds to collection of distinct content portions, where the base layer carries higher priority content portions while the enhancement layers carry lower and lower priority content portions. Although in such an application recovering higher or lower priority portions of content do not have any impact on each others' individual quality, it is desirable to provide better delivery guarantees to the high priority content than the low priority to obtain better system utility.

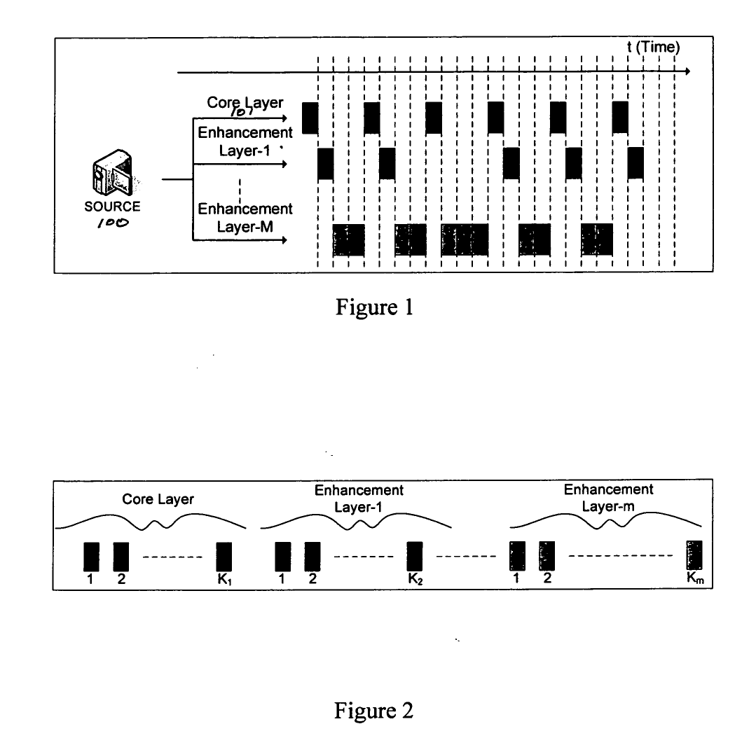

In one embodiment, an encoding system uses different protection levels for each layer using a set of various erasure codes. In one embodiment, each of the erasure codes applied to the layer is different. FIG. 1 shows source content represented as multiple streams of distinct layers. Referring to FIG. 1, the layered source content is arranged chronologically in a time-wise fashion with core layer 101 and multiple enhancement layers 1 . . . M from source 100. In one embodiment, layers are produced at the same encoding time. As shown, each layer has a number of blocks that may be produced at distinct time slots. The blocks from an individual layer may not be in consecutive time slots, such that core layer 101 and enhancement layer-1 or may be produced at 2 or more consecutive time slots such as in the case of enhancement layer-M. Note that, in one embodiment, only one block from one of core layer 101 and enhancement layers 1-M is produced during each time slot, however, this is not a requirement. In one embodiment, the encoding groups each layer together by preserving the chronological order inside the layer, but not necessarily across the layers (e.g., the 3^{rd} packet of core layer in FIG. 2 can correspond to a time later than the 5^{th} packet of enhancement layer “M”).

FIG. 2 illustrates the blocks (or packets) of each layer being grouped together before applying any packet level coding in the application layer. Each of the blocks consists of a sequence of many bits. In one embodiment, a precode demultiplexer is responsible for grouping and preparing each layer for input into the proper precoder. In one embodiment, to group blocks of the same layer together, the precode demultiplexer parses the header of each block which can explicitly indicate the priority level. In another embodiment, the precode demultiplexer examines the payload type, which is defined such that payload type can be mapped onto a priority level. In one embodiment, a mapping function from each priority level to a fixed code gain is used to pass the blocks of a layer to the precoder that has the mapped coding gain.

In one embodiment, the precode demultiplexer groups each layer into a format that the corresponding precoder encoder can accept. The precoder encoder can accept bits, octets, or other types of representation. In one embodiment, the precoder encoder requires the complete layer to generate the original layer information or it can process the precoded layer block by block or in other means. The precode demultiplexer formats the blocks according to such precoder requirements and feeds the appropriate precoder encoder.

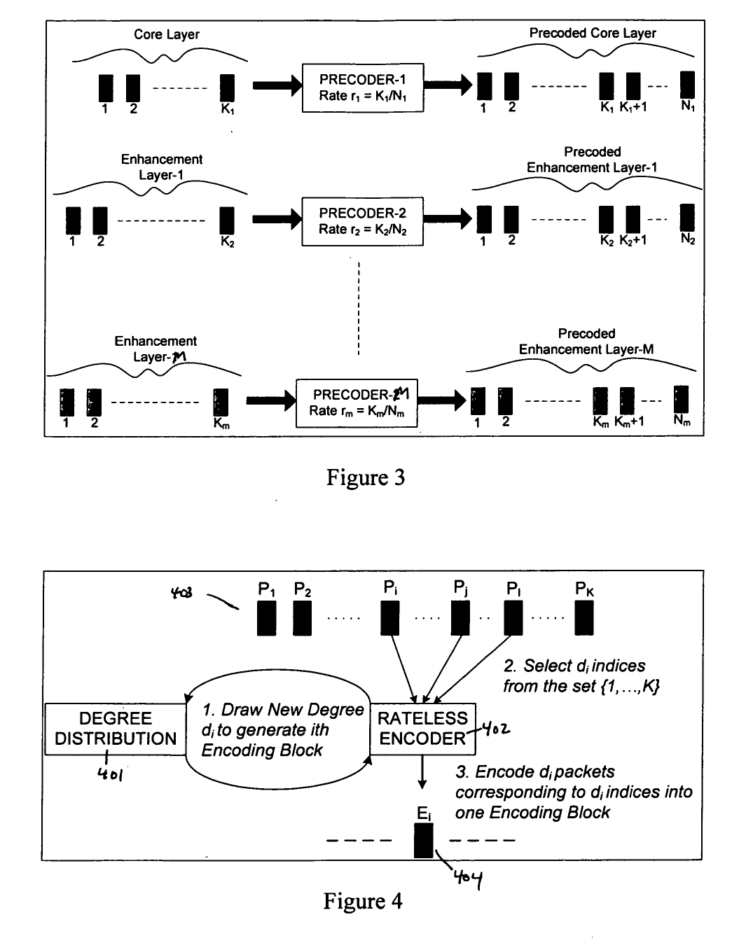

After grouping of a layer is completed, the layer is fed into a precoder that applies an erasure code to encode the original blocks at a desired rate (equivalently protection level). In one embodiment, using the erasure code, the precoder takes all the blocks of a layer and outputs an “encoded layer” whose size in number of blocks is larger than or equal to the size of the original layer. FIG. 3 illustrates each layer being expanded using fixed rate erasure codes that add redundant check packets computed as a function of the original packets over a finite field. This process is referred to herein as preceding. In one embodiment, redundant check packets are computed by performing a binary bitwise exclusive-OR (XOR) of different subsets of the original packets. In another embodiment, the encoded layer can be generated by any finite field algebra. In one embodiment, each layer has a different expansion factor defined by the rate rᵢ of the corresponding precoder. Thus, the core layer of size K₁ blocks is expanded into an “encoded layer” of N₁ blocks (referred to as a precoded core layer) by a precoder using an erasure code of rate K₁/N₁≦1. The same is true of enhancement layer-1 (via precoder-2) through enhancement layer-M (via precoder-M).

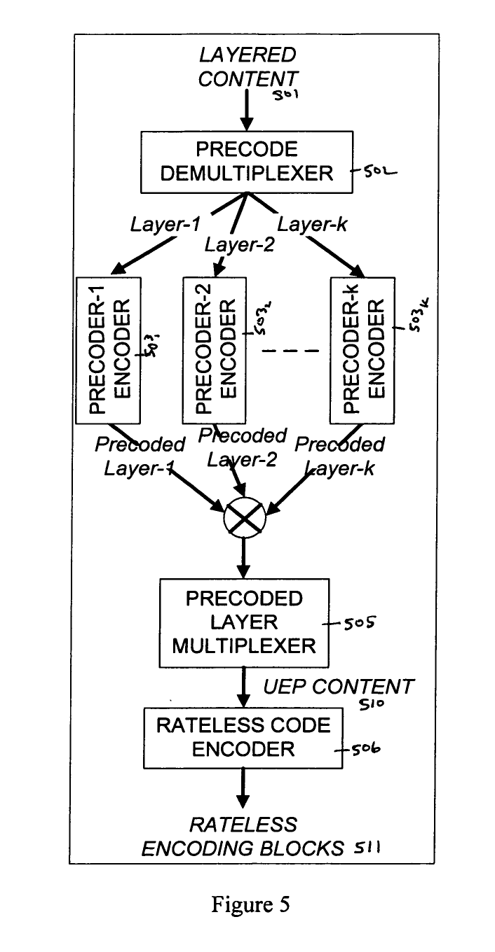

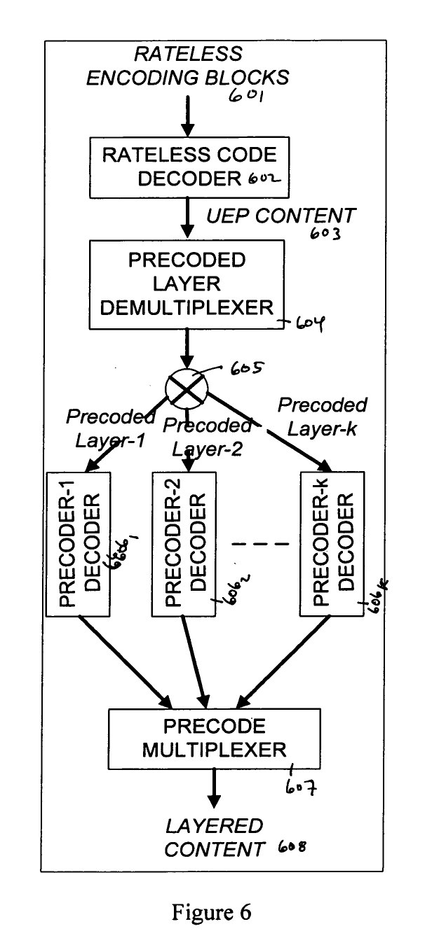

An efficient erasure code can recover the original layer from any sufficient subset of the blocks from the encoded layer, where a sufficient subset in the best cases is defined as one with a size larger than or equal to the size of the original layer in number of blocks. Such codes exist in the literature and can be used (e.g., Reed-Salomon Erasure Codes, Tornado Codes, etc.) and can be readily used as a component in an encoding and decoding apparatus such as the encoding and decoding system of FIG. 5 and FIG. 6, respectively, described in more detail below. Less efficient codes can also be used.

Erasure codes with lower rates provide more protection against the packet losses in the “encoded layer”. Therefore, by using different coding rates for different layers, one can provide a different protection level for each layer. In one embodiment, when rate is one (K/N=1), no protection is enforced on the corresponding layer. In this case, no redundancy has been added in the “encoded” layer. A layer of size K₁ blocks that is expanded into N₁ blocks is more protected than another layer of size K₂ blocks that is expanded into N₂ blocks if the relation N₁/N₂>K₁/K₂ holds.

At the output stage of precoders, a precoded layer multiplexer concatenates each encoded layer one after another and prepares precoded content with unequal protection across the layers (also referred to herein as “UEP content”). Therefore, a rateless encoder can use any rateless code to generate rateless encoding blocks from the UEP content. In one embodiment, the rateless encoder generates a number of unique rateless encoding blocks by encoding random subsets of precoded blocks, where the randomness encompasses both the selection of the size of each subset and the selection of the subset numbers in a well-known manner (e.g., LT codes, online codes, and raptor codes). Although rateless code can be any good performing rateless code, in one embodiment a rateless code with no precoding stage is used.

FIG. 4 illustrates one embodiment structure of a rateless coder that performs the following operation sequence to produce a new encoding block. First, rateless encoder 402 draws a degree dᵢ from a well-performing distribution 401 (e.g., a Robust Soliton Distribution). Second, rateless encoder 402 selects dᵢ blocks uniformly random from the input blocks P₁ . . . Pₖ (403). Third, rateless encoder 402 performs a bitwise XOR operation over the selected blocks to generate the i-th encoding block Eᵢ (404). Note that rateless code does not differentiate between the input blocks. Since the input consists of UEP layers, passing it through such a rateless encoder 402 effectively generates a UEP rateless code structure.

In another embodiment, the encoding blocks of the UEP rateless code can be inverted by passing the encoding blocks first from the decoder of the rateless code used at the encoding stage. Since the encoder is a random code structure, the decoding provides high probabilistic guarantees to recover a certain number of the original message when a sufficiently large number of encoding blocks is received. This combination with the disclosed precoder decoding structure, this behavior in turn provides even higher probabilistic guarantees to recover the higher priority layers (e.g., the core layer and higher priority enhancement layers).

FIG. 5 is a block diagram of one embodiment of an encoder. Each block may comprise hardware (circuitry, dedicated logic, etc.), software (such as is run on a general purpose computer system or a dedicated machine), or a combination of both. Referring to FIG. 5, layer content 501 is input into precode demultiplexor 502. In one embodiment, precode demultiplexer 502 groups, prepares each layer by parsing the header of blocks received from content 501 and accumulating the blocks of the same layer (i.e., the same priority), and inputs each layer into a specific precode encoder that has the coding rate required by the priority level of the layer. As shown, precoder demultiplexor 502 outputs layer-1 . . . layer-k and sends these layers to precoder encoders 503₁ . . . 503ₖ, respectively. Each of precoder encoders 503₁-503ₖ applies an erasure code to the layer to produce a precoded layer. Precoded layer-1 to precoded layer-k are output from precoder encoder 503₁-503ₖ, respectively. Precoded layer multiplexer 505 concatenates each encoded layer one after the other and prepares and generates new UEP content 510. A rateless code encoder 506 receives UEP content 510 and performs rateless encoding to generate rateless encoding blocks 511.

FIG. 6 is a block diagram of one embodiment of a decoder that inverts each stage of one embodiment of an encoder apparatus that is shown in FIG. 5. Each block may comprise hardware (circuitry, dedicated logic, etc.), software (such as is run on a general purpose computer system or a dedicated machine), or a combination of both. Referring to FIG. 6, rateless encoding blocks 601 are received by rateless code decoder 602 which, in response to rateless encoding block 601, generates UEP content 603. A number of different type of decoders may be used for rateless codes. In one embodiment, each rateless encoding block has a header that indicates the sequence number of the blocks used in the XOR operation. In one embodiment, the decoder has the same pseudo-random number generators and can locally generate the exact same sequence of random numbers so that it can simulate which encoding block has information about which input blocks. With extremely low probability, two encoding blocks carry information on the same subset of input blocks. When this happens, it is effectively discarded. For example, a maximum likelihood decoder (ML) decoder forms a linear systems of equations that can be written in matrix form as y=Hx where y and x are N by 1 and K by 1 vectors, and H and N by K matrix. Each entry of x is an input block that is mapped onto a number in finite field. The entries of H are either 1 or 0. If ith row jth column is 1, then ith encoding block (i.e., ith element of y) carries information about the jth input block to the rateless code. Since the encoding block which has information about what input blocks is known in 1's and 0's in H may be filled in. Note that as more encoding blocks are received, the y vector and H matrix are growing in rows. The small number of rows do not provide enough information about x, and more and more entries of x are received as the rows of y and H grow. In one embodiment, multiplications and additions are finite field operations that correspond to the XOR operations. In one embodiment, the ML decoder performs Gaussian Elimination and recovers all the recoverable entries of x. In another embodiment, other detectors like Belief Propagation may be used to check the rows of H with single 1 which immediately decodes the corresponding entry in x, and then subtract those rows from the rest of the rows, thereafter the process is repeated.

After decoding the rateless codes, a precoded layer demultiplexer 604 receives the UEP content 603 and generates precoded layers, namely precoded layer-1 to precoded layer-k. Each of the precoded layers is input to a precoded decoder. That is, precoded layer-1 the precoded layer-k is input to precoders 606₁-606ₖ, respectively. The output of each of the precode decoders 606₁-606ₖ is a layer. Each of these layers are input to precode multiplexer 607 which, in response to the layers from precoder decoder 606₁-606ₖ, generates layered content 608.

In another embodiment, referring to FIG. 6, when the output of any of the precode decoder 606₁-606ₖ is ready (i.e., a layer is recovered), that output can be fed back to the corresponding precoder encoder 503₁-503ₖ (referring to FIG. 5) to generate the complete precoded layer that is used as an input to the rateless code encoder 506 to generate rateless encoding blocks. The recovered precoded layers in this way can be further fed back to the rateless code decoder (block 602 in FIG. 6) to recover even more packets from the other precoded layers.

Communication Systems

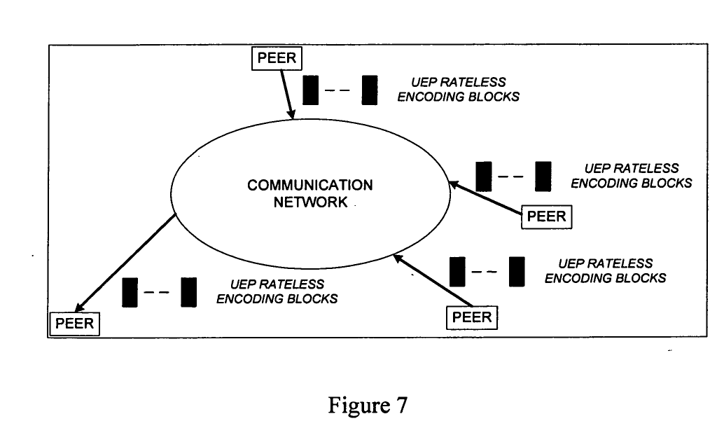

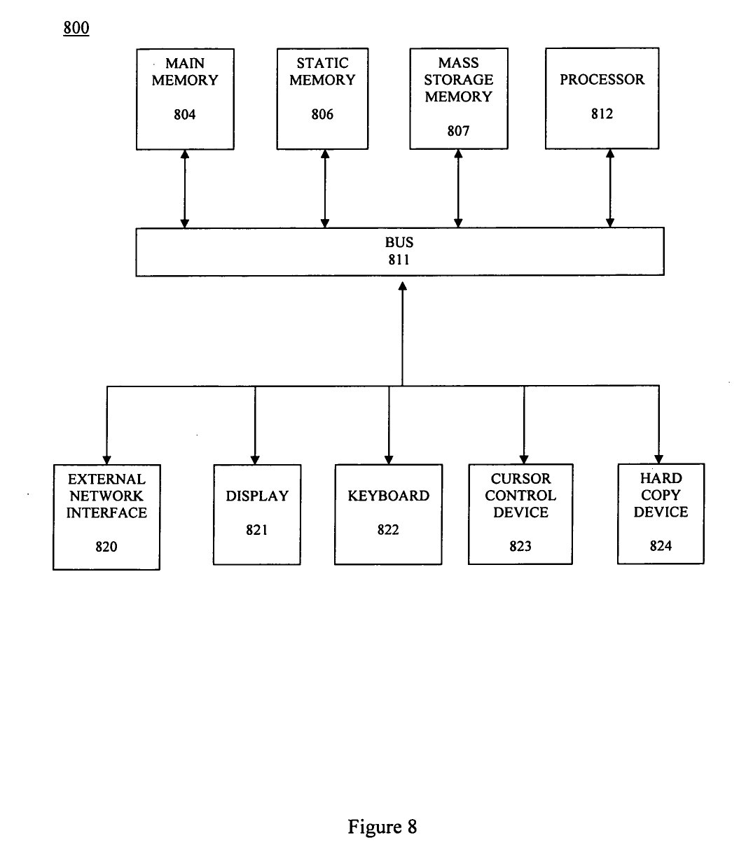

In one embodiment, a communication system includes nodes or peers that include the encoder and/or a decoder as set forth herein. This is especially beneficial to in wireless and mobile peer-to-peer (P2P) communication systems for scalable content distribution. FIG. 7 is a block diagram of one embodiment of a P2P system that utilizes the UEP rateless code structure described herein for layered content distribution from multiple nodes to multiple nodes. A number of peers are shown. In one embodiment, the peers have limited budget in terms of number of packets they can commit for content distribution due to their intermittent poor connectivity, due to their power budget, and/or due to their arbitrary decision. Similarly the receiving nodes can have a deadline for the content download. This effectively introduces a constraint in number of packets (or blocks) that can be sent to the receiver site.

The senders themselves can have the original content or they can simply have the UEP-rateless encoding blocks. As long as each peer has a different encoding block (i.e. any encoding block is stored at one peer only), peers can start sending encoding blocks without conciliating their overlaps. In one embodiment, the peers are also agnostic with respect to which encoding block carries more information on higher priority layers, i.e., from their point of view, each encoding block is equivalent. Therefore, when individual peers have limitations in the number of blocks they can contribute, they do not require a complex decision process to determine which block to send. In fact, in such uncoordinated systems, layered source coding cases can be considered where there are even multiple core layers, as in a multi-descriptive scheme, and full, partial, or no hierarchy in the enhancement layers. Thus, when the constraint does not allow the reception of minimum number of encoding blocks that is necessary for correct recovery of the high priority layers (i.e. the download is interrupted), better fidelity is provided for recovering the higher priority layers.

Examples of Advantages of Various Embodiments

Embodiments of the present invention have one or more of the following advantages. In one embodiment, an unequal error protected rateless code for layered content is provided. When different layers have different levels of importance to provide a high quality presentation or to provide a higher utility for the network operator and the end users, such a code/transmission structure can provide better recovery performance for the more important layers while preserving the advantages of the rateless codes. These advantages of rateless codes can include: (1) any change in terms of the packet losses occurring inside the network can be accommodated on the fly without changing the code structure; (2) availability of the data at many nodes is satisfied without requiring explicit information of who has what part of the content, which reduces the risk against bottleneck nodes only which has a particular portion of the content; (3) when data is source from multiple nodes, receiver node does not need to know which node has which part and source nodes do not need require set reconciliation to avoid duplicate transmissions from different nodes, thereby realizing asynchronous downloads; and (4) each receiver can operate at their own pace and within their constraints independent of the other receivers.

Advantages with the unequal protection structure leads to better source fidelity in situations where not all the source layers are successfully transmitted.

An embodiment of the invention reduces complexity when lower rate precoding is applied to layers of smaller size. Embodiments of the invention also provide a very modular way of UEP-rateless code structure where any precoder or the rateless code structure can be altered by another one that is better suited to the circumstances without changing the internal structure of the erasure and rateless codes.

Another embodiment of the invention allows the decoder to perform iterative decoding. When a high priority layer is recovered first as provided by the UEP protection, it can be used to generate all the blocks of the precoded layer. For instance when the core layer consists of 100 blocks and it is precoded at rate ½ to generate a precoded layer of 200 blocks, it suffices at the rateless decoder to recover only 100 blocks from this precoded layer. These 100 blocks are sufficient for the ½ rate erasude code decoder to recover the original 100 blocks of the core layer. At that instant, one can also regenerate all 200 blocks of the precoded layer by passing 100 original blocks through the encoder of rate ½ erasure code. Thus, instantaneously the rateless code decoder has access to an extra 100 blocks used at the encoding stage. This extra information can be used in the latter iterations to recover more packets from the lower priority precoded layers.

An Example of a Computer System

FIG. 9 is a block diagram of an exemplary computer system that may perform one or more of the operations described herein. Referring to FIG. 9, computer system 900 may comprise an exemplary client or server computer system. Computer system 900 comprises a communication mechanism or bus 911 for communicating information, and a processor 912 coupled with bus 911 for processing information. Processor 912 includes a microprocessor, but is not limited to a microprocessor, such as, for example, Pentium™, PowerPC™, Alpha™, etc.

System 900 further comprises a random access memory (RAM), or other dynamic storage device 904 (referred to as main memory) coupled to bus 911 for storing information and instructions to be executed by processor 912. Main memory 904 also may be used for storing temporary variables or other intermediate information during execution of instructions by processor 912.

Computer system 900 also comprises a read only memory (ROM) and/or other static storage device 906 coupled to bus 911 for storing static information and instructions for processor 912, and a data storage device 907, such as a magnetic disk or optical disk and its corresponding disk drive. Data storage device 907 is coupled to bus 911 for storing information and instructions.

Computer system 900 may further be coupled to a display device 921, such as a cathode ray tube (CRT) or liquid crystal display (LCD), coupled to bus 911 for displaying information to a computer user. An alphanumeric input device 922, including alphanumeric and other keys, may also be coupled to bus 911 for communicating information and command selections to processor 912. An additional user input device is cursor control 923, such as a mouse, trackball, trackpad, stylus, or cursor direction keys, coupled to bus 911 for communicating direction information and command selections to processor 912, and for controlling cursor movement on display 921.

Another device that may be coupled to bus 911 is hard copy device 924, which may be used for marking information on a medium such as paper, film, or similar types of media. Another device that may be coupled to bus 911 is a wired/wireless communication capability 925 to communication to a phone or handheld palm device.

Note that any or all of the components of system 900 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method comprising:
dividing content into a plurality of content layers based on priority;
expanding each layer into an encoded layer using an erasure code at a coding rate to produce a plurality of encoding layers, wherein the coding rate for each layer is set based on the priority and reduces as the priority of the content layers increases;
concatenating a plurality of encoding layers produced by passing the plurality of layers through fixed rate precoders; and
performing rateless encoding on the concatenated plurality of encoding layers to produce rateless encoding blocks.

2. The method defined in claim 1 wherein expanding each layer into an encoded layer using an erasure code at a coding rate to produce a plurality of encoding layers comprises passing each content layer through a fixed rate precoder to expand each content layer into an encoding layer, wherein a higher priority layer is passed through a first fixed rate precoder with a lower precoder rate than a second fixed rate precoder used to produce an encoding layer from a lower priority layer.

3. The method defined in claim 1 wherein performing rateless encoding comprises generating an encoding block by
selecting a degree from a distribution;
selecting blocks from the concatenated plurality of encoding layers based on the degree; and
performing a bitwise exclusive-OR (XOR) operation over the selected blocks to create the encoding block.

4. The method defined in claim 1 wherein blocks within each of the plurality of content layers are ordered chronologically.

5. The method defined in claim 4 wherein each of the blocks comprises a sequence of bits.

6. The method defined in claim 1 wherein the content comprises a plurality of blocks, and each of the plurality of layers includes a number of blocks.

7. The method defined in claim 6 wherein the number of blocks corresponds to distinct time slots.

8. The method defined in claim 1 wherein each encoding layer is larger than or equal, in size to its corresponding content layer.

9. An encoder comprising:
a precode demultiplexer to generate a plurality of content layers in response to content, where each of the plurality of content layers has a priority and at least one of the plurality of content layers has a higher priority than another one of the plurality of content layers;
a bank of precoders to encode the plurality of content layers by expanding each layer into an encoded layer using an erasure code at a coding rate set based on the priority, wherein the coding rate reduces as the priority of the content layers increases;
a precoded layer multiplexer to concatenate a plurality of encoding layers produced by the precoding stage; and
a rateless code encoder to perform rateless encoding on the concatenated plurality of encoding layers to produce rateless encoding blocks.

10. The apparatus defined in claim 9 wherein precoder in the bank encodes one of the plurality of content layers at a fixed rate using an erasure code to produce an encoding layer, wherein a higher priority layer is passed through a first fixed rate precoder encoder having a lower precoder rate than a second fixed rate precoder encoder used to produce an encoding layer from a lower priority layer.

11. The apparatus defined in claim 9 wherein the rateless code encoder generates at least one of the encoding blocks by
selecting a degree from a distribution;
selecting blocks from the concatenated plurality of encoding layers based on the degree; and
performing a bitwise exclusive-OR (XOR) operation over the selected blocks to create the encoding block.

12. An article of manufacture having one or more computer readable media storing instructions thereon which, when executed by a system, cause the system to perform a method comprising:
dividing content into a plurality of content layers based on priority;
expanding each layer into an encoded layer using an erasure code at a coding rate to produce a plurality of encoding layers, wherein the coding rate for each layer is set based on the priority and reduces as the priority of the content layers increases;
concatenating a plurality of encoding layers produced by passing the plurality of layers through fixed rate precoders; and
performing rateless encoding on the concatenated plurality of encoding layers to produce rateless encoding blocks.

13. A method comprising:
(a) performing rateless decoding of a plurality of rateless encoding blocks using a rateless decoder to produce first content;
(b) dividing the first content into a plurality of precoded layers;
(c) generating a plurality of content layers by performing erasure code decoding on the plurality of precoded layers, wherein each of the plurality of content layers has a priority and a first precoded layer corresponding to a first of the plurality of content layers with a priority higher than a second of the plurality of content layers has more information than the second precoded layer corresponding to the second content layer; and
(d) further comprising the plurality of content layers to recover second content.

14. The method defined in claim 13 wherein the first content comprises unequal error protection content.

15. The method defined in claim 14 wherein further processing the plurality of content layers comprises sorting the plurality of content layers.

16. The method defined in claim 14 wherein further processing comprises:
inputting at least one of the plurality of content layer into the precoder encoder to generate additional precoded layers; and
feeding the additional precoded layer to the rateless decoder; and
repeating operations (a)-(d) using the one or more additional precoded layers.

17. An article of manufacture having one or more computer readable media storing instructions thereon which, when executed by a system, cause the system to perform a method comprising:
performing rateless decoding of a plurality of rateless encoding blocks to produce first content;
dividing the first content into a plurality of precoded layers;
generating a plurality of content layers by performing erasure code decoding on the plurality of precoded layers, wherein each of the plurality of content layers has a priority and a first precoded layer corresponding to a first of the plurality of content layers with a priority higher than a second of the plurality of content layers has more information than the second precoded layer corresponding to the second content layer; and
sorting the plurality of content layers to recover second content.

18. An apparatus comprising:
a rateless code decoder to perform rateless decoding of a plurality of rateless encoding blocks to produce first content;
a precoded layer demultiplexer to divide the first content into a plurality of precoded layers;
a plurality of precoder decoders to generate a plurality of content layers by performing erasure code decoding on the plurality of precoded layers, wherein each of the plurality of content layers has a priority and a first precoded layer corresponding to a first of the plurality of content layers with a priority higher than a second of the plurality of content layers has more information than the second precoded layer corresponding to the second content layer; and
a precode multiplexer to sort the plurality of content layers to recover second content.

19. The apparatus defined in claim 18 wherein blocks within each of the plurality of content layers are ordered chronologically.

20. The apparatus defined in claim 18 wherein at least two of the content layers have a different priority level.

21. The apparatus defined in claim 18 wherein each encoding layer is larger than or equal, in size to its corresponding content layer.

22. A method for performing layered content distribution, the method comprising:
receiving packets containing a plurality of rateless encoding blocks from a plurality of peers, wherein the rateless encoding blocks are encoded with unequal error protected (UEP) rateless codes;
performing rateless decoding of the plurality of rateless encoding blocks to produce first content;
dividing the first content into a plurality of precoded layers;
generating a plurality of content layers by performing erasure code decoding on the plurality of precoded layers, wherein each of the plurality of content layers has a priority and a first precoded layer corresponding to a first of the plurality of content layers with a priority higher than a second of the plurality of content layers has more information than the second precoded layer corresponding to the second content layer; and
sorting the plurality of content layers to recover second content.

23. The method defined in claim 22 wherein the packets correspond to a download for a mobile device, wherein the plurality of peers corresponds to mobile nodes.

24. The method defined in claim 22 wherein the packets correspond to a software update download.

25. The method defined in claim 22 wherein the packets correspond to a set of content portions concatenated together to generate larger content, where content portions in the set have different priorities.

26. The method defined in claim 22 wherein the peers are in a peer-to-peer communication system.

27. A communication system comprising:
a plurality of nodes, wherein at least one node is operable to receive rateless encoded blocks of a requested content from multiple sources, wherein the at least one of the plurality of nodes includes the decoder set forth in claim 17.

28. The communication system defined in claim 27 wherein the nodes comprise a plurality of peers.

29. The system defined in claim 27 wherein at least one node includes the encoder of claim 10.

30. The system defined in claim 27 wherein the plurality of nodes communicate through a network and are one or more of a group consisting of: stationary, mobile, wireless and wired devices.

31. The system defined in claim 27 wherein the plurality of sources comprises two or more of a group consisting of other nodes in the communication system and one or more servers.

32. The system defined in claim 27 wherein the plurality of nodes comprises a plurality of overlay nodes.
